(19) United States
(12) Patent Application Publication
(10) Pub. No.: US 2025/0079729 A1
(43) Pub. Date: Mar. 6, 2025

(54) SOCKET

(71) Applicant: OMRON CORPORATION, Kyoto-shi, Kyoto (JP)

(72) Inventors: Shinya TSUJI, Kyoto-shi, Kyoto (JP); Keisuke YANO, Kyoto-shi, Kyoto (JP)

(21) Appl. No.: 18/727,392

(22) PCT Filed: Dec. 26, 2022
(86) PCT No.: PCT/JP2022/047821

§ 371 Date: Jul. 9, 2024

(30) Foreign Application Priority Data
Jan. 31, 2022 (JP) 2022-013303

(51) Int. Cl. H01R 9/26; H01H 50/04

(52) U.S. Cl. CPC H01R 9/2616; H01R 9/2633; H01H 50/048

(57) ABSTRACT

A socket includes a housing, a lever attached to the housing in a state in which the lever is rotatable about a rotation axis, and a restriction member configured to restrict rotation of the lever. The lever includes an operating portion extending from the rotation axis in a radial direction with respect to the rotation axis, and the lever is configured to rotate about the rotation axis between a first position and a second position. The restriction member is attached to the operating portion in a state in which, when the lever is located at the first position, the restriction member is movable along the radial direction between a restriction position that is located between the operating portion and the second wall portion in the circumferential direction and rotation of the lever is restricted, and a release position that is a position farther from the rotation axis in the radial direction than the restriction position and restriction of rotation of the lever is released.

### CROSS REFERENCE TO RELATED APPLICATIONS

This is the U.S. national stage of application No. PCT/JP2022/047821, filed on Dec. 26, 2022. Priority under 35 U.S.C. § 119(a) and 35 U.S.C. § 365(b) is claimed from Japanese Application No. 2022-013303, filed Jan. 31, 2022, the disclosure of which is also incorporated herein by reference.

### TECHNICAL FIELD

The present disclosure relates to a socket.

### BACKGROUND ART

Patent Document 1 discloses a relay socket including a release lever capable of preventing a relay mounted on a relay mounting portion from rotating and dropping off. In the relay socket, the release lever includes an abutment portion, which faces a back surface of the relay mounted on the relay mounting portion, and an operating portion, which is continuous with the abutment portion and extends to a front surface side. The release lever is configured to be swingable between a holding position and a retraction position.

### PRIOR ART DOCUMENT

### Patent Document

Patent Document 1: JP 2005-108767 A

### SUMMARY OF THE INVENTION

### Problems to be Solved by the Invention

In the relay socket described above, when a downward external force is applied to the release lever, there is a possibility that the release lever rotates, and the relay drops off from the relay mounting portion.

An object of the present disclosure is to provide a socket capable of preventing an electronic device connected thereof from dropping off due to rotation of a lever.

### Solutions to the Problems

A socket according to one aspect of the present disclosure includes:
a housing including a first wall portion including a connection surface to which an electronic device is to be connected and a second wall portion that is positioned with a gap from the first wall portion in a first direction, which is a direction along the connection surface, and extends in a second direction intersecting the connection surface;
a lever that is located in the gap, attached to the housing in a state in which the lever is rotatable about a rotation axis extending along the connection surface, and configured to release connection of the electronic device by being rotated about the rotation axis; and
a restriction member configured to restrict rotation of the lever, wherein
the lever includes an operating portion extending from the rotation axis in a radial direction with respect to the rotation axis, and
the lever is configured to rotate about the rotation axis between a first position at which the operating portion is adjacent to the electronic device connected to the connection surface in a circumferential direction with respect to the rotation axis, and a second position at which the operating portion is farther from the electronic device connected to the connection surface in the circumferential direction than the first position and adjacent to the second wall portion, and
the restriction member is attached to the housing or the operating portion in a state in which, when the lever is located at the first position, the restriction member is movable along the radial direction between a restriction position that the restriction member is located between the operating portion and the second wall portion in the circumferential direction and at which the restriction member restricts rotation of the lever, and a release position that is a position farther from the rotation axis in the radial direction than the restriction position and at which restriction of rotation of the lever by the restriction member is released.

### Effects of the Invention

According to the socket of the above aspect, a socket is achieved that is capable of preventing an electronic device connected thereof from dropping off due to rotation of a lever.

### BRIEF DESCRIPTION OF THE DRAWINGS

FIG. 1 is a perspective view illustrating a socket according to an embodiment of the present disclosure.

FIG. 2 is a first plan view showing the socket of FIG. 1 in a state in which a lid portion is removed.

FIG. 3 is a second plan view showing the socket of FIG. 1 in a state in which the lid portion is removed.

FIG. 4 is a third plan view showing the socket of FIG. 1 in a state in which the lid portion is removed.

FIG. 5 is a perspective view showing a lever in a state in which a restriction member of the socket of FIG. 1 is attached.

FIG. 6 is an enlarged perspective view showing a portion of the lever of the socket of FIG. 1 to which the restriction member is to be attached.

FIG. 7 is a plan view showing the restriction member of the socket of FIG. 1.

FIG. 8 is a plan view illustrating a modification of the socket of FIG. 1.

### DETAILED DESCRIPTION

Hereinafter, an example of the present disclosure will be described with reference to the accompanying drawings. The following description is merely exemplary in nature and is not intended to limit the present disclosure, its application, or its use. Furthermore, the drawings are schematic, and ratios of dimensions and the like do not necessarily match actual ones.

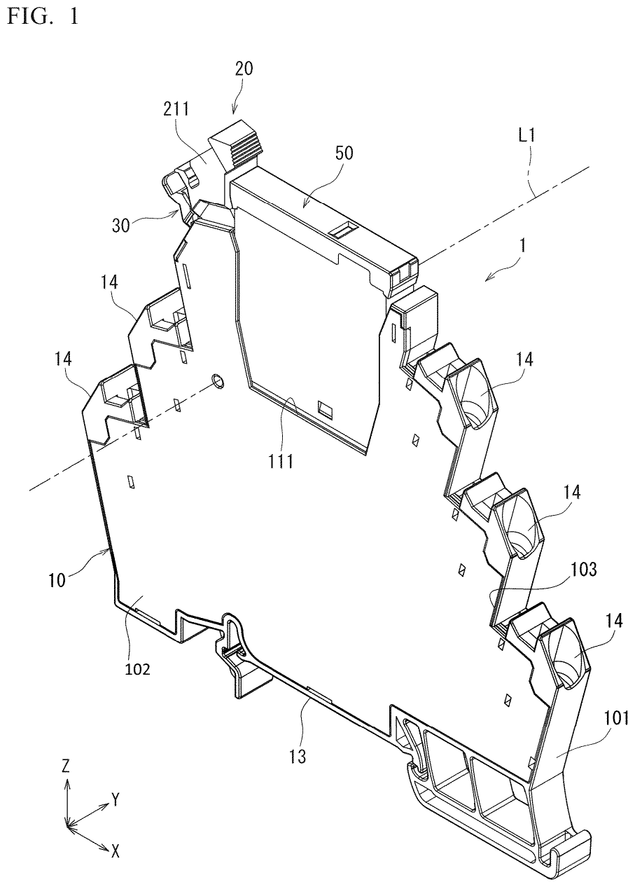

As shown in FIG. 1, a socket 1 of the present disclosure includes a housing 10, a lever 20 rotatably attached to the housing 10, and a restriction member 30.

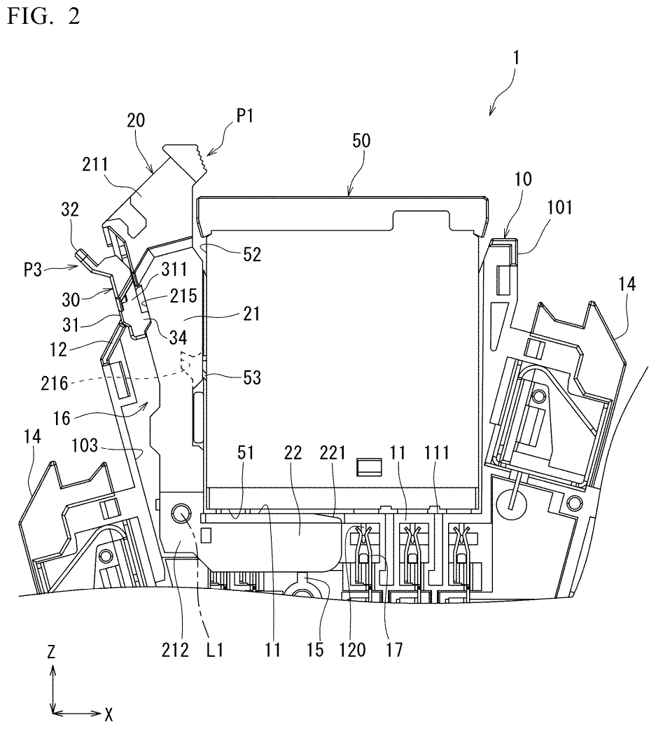

As illustrated in FIG. 2, the housing 10 includes a first wall portion 11 which includes a connection surface 111 to which an electronic device 50 includes an electromagnetic relay is connected, and a second wall portion 12. In the present embodiment, the housing 10 includes a housing main body 101 which has a thin plate shape and includes an opening 103 at one end in a thickness direction (for example, Y direction), and a lid portion 102 which closes the opening 103 of the housing main body 101. FIGS. 2 to FIG. 4 show the socket 1 with the lid portion 102 removed.

As an example, as illustrated in FIG. 1, the first wall portion 11 is located substantially at a center in a width direction of the housing main body 101 (for example, X direction, hereinafter referred to as a first direction). The first wall portion 11 extends in the first direction X and has a thickness along a height direction (for example, the Z direction) of the housing 10. As an example, the connection surface 111 constitutes a part of an outer surface of the housing main body 101 and extends in the XY directions. The connection surface 111 includes an opening (not illustrated) configured to accommodate a contact portion 22 of the lever 20 described below and a plurality of openings (not illustrated) each configured to accommodate a terminal 120 extending from the electronic device 50.

As illustrated in FIG. 2, the second wall portion 12 is positioned with a gap 16 from the first wall portion 11 in the first direction X along the connection surface 111. The lever 20 is located in the gap 16. The second wall portion 12 extends in a second direction (for example, Z direction) intersecting the connection surface 111 and in a direction from the connection surface 111 toward an outside of the housing 10.

As illustrated in FIG. 1, the housing 10 is configured to be attachable to an external device (not illustrated) such as a control panel via an attachment portion 13 located on a side opposite to the connection surface 111 in the second direction Z. A plurality of wiring connection portions 14 is provided on both sides of the first wall portion 11 in the first direction X of the housing 10. External wiring (not illustrated) is connected to each wiring connection portion 14.

As an example, the electronic device 50 has a substantially rectangular parallelepiped shape and includes a bottom portion 51 and a side portion 52. The bottom portion 51 faces the connection surface 111 in a state in which the electronic device 50 is connected to the connection surface 111. The side portion 52 extends in the second direction Z and faces an operating portion 21 of the lever 20 in the first direction X in a state in which the electronic device 50 is connected to the connection surface 111. A projection 53 is provided in the middle in the second direction Z of the side portion 52 of the electronic device 50. The bottom portion 51 of the electronic device 50 includes a terminal 120 extending from the bottom portion 51 in the second direction Z and accommodated in the housing 10. The terminal 120 is connected to a terminal connection portion 17 provided inside the housing 10. As an example, the terminal connection portion 17 includes a pair of leaf springs configured to hold the terminal 120 from the first direction X.

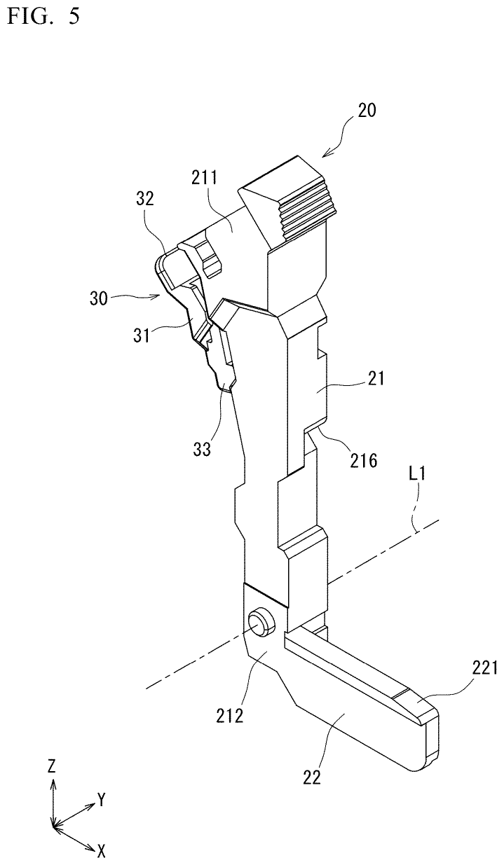

The lever 20 is attached to the housing 10 so as to be rotatable about a rotation axis L1 extending along the connection surface 111. In the present embodiment, as illustrated in FIG. 5, the lever 20 has a substantially L shape as a whole, and includes an operating portion 21 and a contact portion 22. The rotation axis L1 is located at an end portion 212 of the operating portion 21 located inside the housing 10 (in other words, the end portion 212 at one of the two ends of the operating portion 21 in a direction in which the operating portion 21 extends that is closer to the connection surface 111).

As illustrated in FIG. 5, as an example, the operating portion 21 has a rod shape extending from the rotation axis L1 in a radial direction with respect to the rotation axis L1 (hereinafter referred to as a radial direction). As illustrated in FIG. 1, an end portion 211 at one of the two ends of the operating portion 21 in the direction in which the operating portion 21 extends that is farther from the rotation axis L1 is located outside the housing 10.

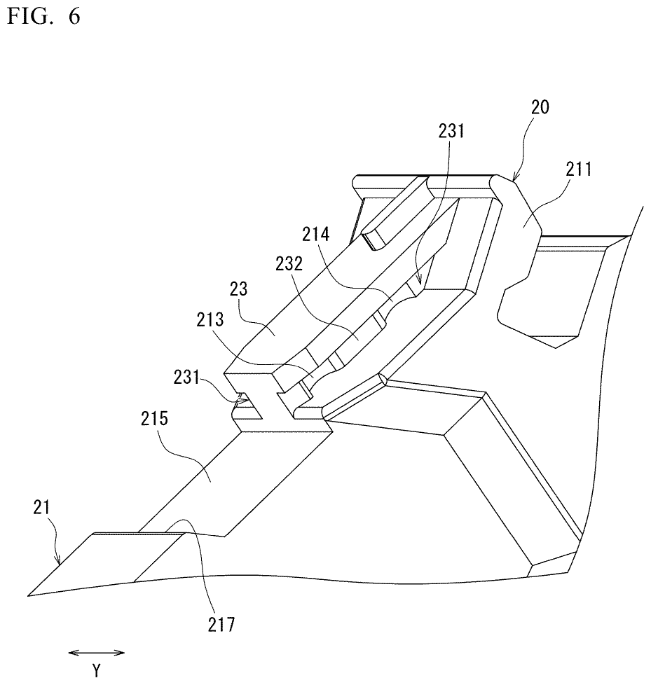

In the present embodiment, the operating portion 21 includes a first recess 213 (see FIG. 6) and a second recess 214 (see FIG. 6), which open in a width direction intersecting a circumferential direction and the radial direction (e.g., Y direction), a third recess 215 (see FIG. 6), which opens facing the restriction member 30 in the circumferential direction, and a fourth recess 216 (see FIG. 5), which opens facing the electronic device 50 in the circumferential direction. As an example, the operating portion 21 includes a pair of first recesses 213 and a pair of second recesses 214. Each recess of the pair of first recesses 213 opens in mutually opposite direction in the width direction Y, and each recess of the pair of second recesses 214 opens in mutually opposite direction in the width direction Y.

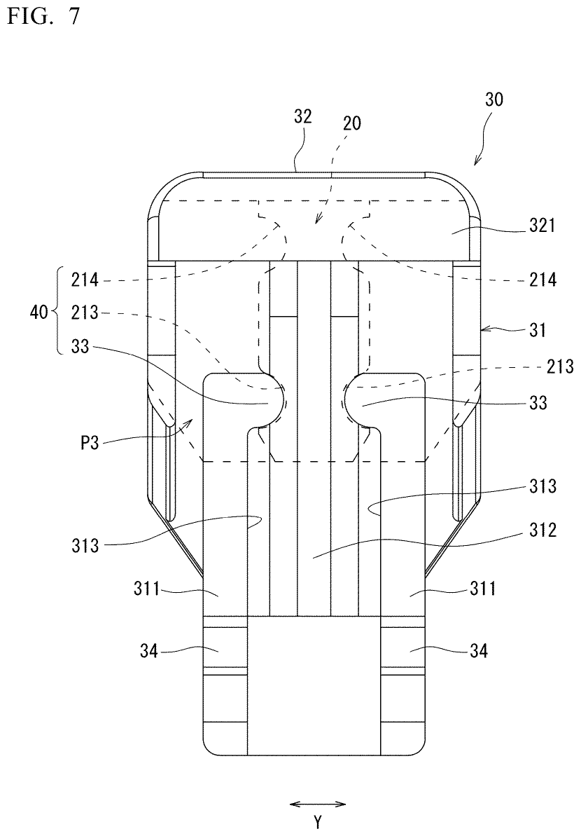

Each first recess 213 and each second recess 214 are configured to accommodate and hold first protruding portions 33 of the restriction member 30 described below (see FIG. 7). Each first recess 213 is located closer to the rotation axis L1 than each second recess 214 in the radial direction. Each first recess 213 is provided at a position corresponding to a restriction position P3 of the restriction member 30 described below. Each second recess 214 is provided at a position corresponding to a release position P4 of the restriction member 30 described below. As an example, as illustrated in FIG. 6, the operating portion 21 includes a support wall portion 23 that protrudes from a surface facing the restriction member 30 in the circumferential direction and an approaching direction toward the restriction member 30 and extends in the radial direction. The support wall portion 23 includes a groove portion 231 extending in the radial direction on both sides in the width direction Y. One first recess 213 and one second recess 214 are provided in a bottom surface 232 of each groove portion 231.

The third recess 215 extends along the radial direction and is configured to accommodate a second protruding portion 34 of the restriction member 30 described below (see FIG. 2). As illustrated in FIG. 7, an inclined surface 217 is provided at one of the two ends in the radial direction of the third recess 215 that is closer to the rotation axis L1 (in other words, the end farther from the support wall portion 23). The inclined surface 217 is inclined from an opening of the third recess 215 toward a bottom surface of the third recess 215 in the circumferential direction with increasing distance from the rotation axis L1 in the radial direction.

The fourth recess 216 is configured to accommodate the projection 53 of the electronic device 50 when the operating portion 21 is located at a first position P1 (see FIG. 2). When the projection 53 of the electronic device 50 is accommodated in the fourth recess 216, a movement of the electronic device 50 in the second direction Z and in a direction away from the connection surface 111 is restricted.

As illustrated in FIG. 5, a contact portion 22 extends from the end portion 212 at one of the two ends of the operating portion 21 in the direction in which the operating portion 21 extends that is closer to the rotation axis L1, in the radial direction and in a direction intersecting the direction in which the operating portion 21 extends. The contact portion 22 is configured to rotate about the rotation axis L1 together with the operating portion 21.

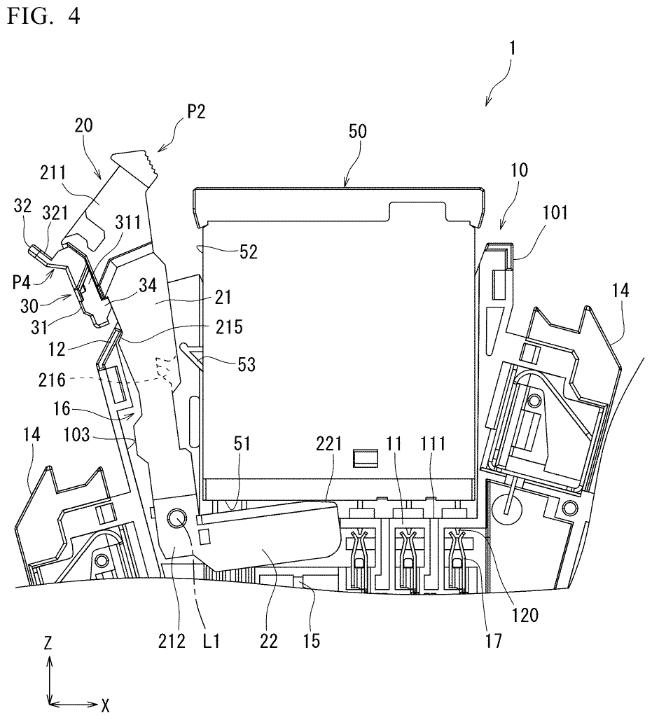

The lever 20 is configured to rotate about the rotation axis L1 between the first position P1 and a second position P2. As illustrated in FIG. 2, the first position P1 is a position at which the operating portion 21 is adjacent to the electronic device 50 connected to the connection surface 111 in the circumferential direction with respect to the rotation axis L1 (hereinafter referred to as the circumferential direction). At the first position P1, movement of the lever 20 in the circumferential direction and in a direction toward the electronic device 50 is restricted by a projection 15 provided on the housing 10. The projection 15 is located farther from the connection surface 111 than the contact portion 22 in the circumferential direction. The contact portion 22 is configured to be capable of coming into contact with the projection 15 at the first position P1. As illustrated in FIG. 4, the second position P2 is a position at which the operating portion 21 is farther from the side portion 52 of the electronic device 50 connected to the connection surface 111 than the first position P1 in the circumferential direction and is a position adjacent to the second wall portion 12 of the housing 10. The operating portion 21 is configured such that the bottom surface of the third recess 215 comes into contact with the second wall portion 12 of the housing 10 at the second position P2. That is, a rotation range of the lever 20 is defined by the housing 10.

As illustrated in FIG. 2, when the lever 20 is located at the first position P1, the contact portion 22 is located inside the housing 10 in a state in which a distal end portion 221, which is an end portion farther from the operating portion 21 in the first direction X, faces the connection surface 111 in the circumferential direction. As illustrated in FIG. 4, when the lever 20 is located at the second position P2, the contact portion 22 is located outside the housing 10 with the distal end portion 221 facing the connection surface 111 in the circumferential direction. That is, when the lever 20 is rotated from the first position P1 to the second position P2 with the electronic device 50 connected to the connection surface 111, the contact portion 22 presses the bottom portion 51 of the electronic device 50 to move the electronic device 50 in the second direction Z and in the direction away from the connection surface 111. As a result, the electronic device 50 is disconnected from the socket 1.

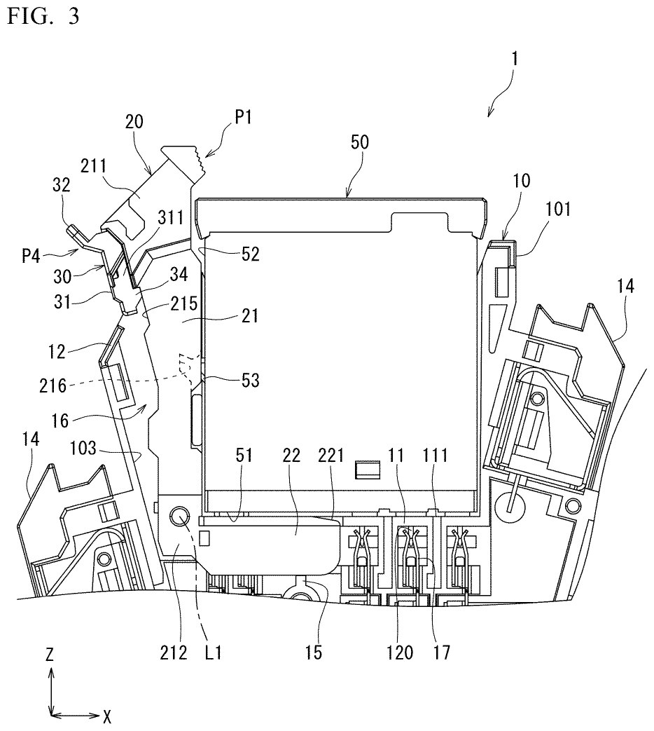

The restriction member 30 is attached to, as an example, the operating portion 21 in a state in which the restriction member 30 is movable along the radial direction between a restriction position P3 and a release position P4. As illustrated in FIG. 2, when the lever 20 is located at the first position P1, the restriction position P3 is a position that the restriction member 30 is located between the operating portion 21 and the second wall portion 12 in the circumferential direction and restricts the rotation of the lever 20. As illustrated in FIG. 3 and FIG. 4, the release position P4 is a position farther from the rotation axis L1 than the restriction position P3 in the radial direction, and is a position at which the restriction of the rotation of the lever 20 by the restriction member 30 is released.

In the present embodiment, as illustrated in FIG. 7, the restriction member 30 includes a main body portion 31, and a pinch portion 32, a first protruding portion 33, and a second protruding portion 34. The pinch portion 32, the first protruding portion 33, and the second protruding portion 34 are provided on the main body portion 31 respectively. As an example, the restriction member 30 includes a pair of first protruding portions 33 and a pair of second protruding portions 34.

As illustrated in FIG. 7, the main body portion 31 includes a pair of wall portions 311 each having a shape of a substantially rectangular plate with the radial direction as a longitudinal direction thereof and each extending from an end closer to the rotation axis L1 to approximately a center of the main body portion 31. The wall portions 311 are positioned with a gap 312 therebetween in the width direction Y.

As illustrated in FIG. 2, the pinch portion 32 is located at one of the two ends of the main body portion 31 in the radial direction that is farther from the rotation axis L1. As an example, the pinch portion 32 has a shape of a substantially rectangular thin plate (see FIG. 7). As viewed along the width direction Y, the pinch portion 32 extends in a direction away from the main body portion 31 in the circumferential direction and in a direction away from the rotation axis L1 in the radial direction.

As illustrated in FIG. 7, the pair of first protruding portions 33 is located approximately at the center of the main body portion 31 in the radial direction. Specifically, the pair of first protruding portions 33 is positioned at one of the two ends of each wall portion 311 in the radial direction that is farther from the rotation axis L1, and protrudes in the width direction Y and in an approaching direction toward each other. Each first protruding portions 33 includes a curved distal end. In the present embodiment, the pair of first protruding portions 33 constitutes a holding mechanism 40 that holds the restriction member 30 at the restriction position P3 and the release position P4 together with the first recesses 213 and the second recesses 214 of the operating portion 21.

As illustrated in FIG. 2, the pair of second protruding portions 34 is located at one of the two ends of the main body portion 31 in the radial direction that is closer to the rotation axis L1. Each second protruding portion 34 protrudes from the main body portion 31 in the circumferential direction and in an approaching direction toward the operating portion 21.

The socket 1 can exert the following effects.

The socket 1 includes the housing 10, the lever 20, and the restriction member 30. The housing 10 includes the first wall portion 11 which includes the connection surface 111 to which the electronic device 50 is to be connected, and the second wall portion 12 which is positioned with the gap 16 from the first wall portion 11 in the first direction, which is a direction along the connection surface 111, and extends in the second direction intersecting the connection surface 111. The lever 20 is located in the gap 16 and attached to the housing 10 so as to be rotatable about the rotation axis L1 extending along the connection surface 111, and configured to release the connection of the electronic device 50 by being rotated about the rotation axis L1. The restriction member 30 is configured to restrict the rotation of the lever 20. The lever 20 includes the operating portion 21 extending from the rotation axis L1 in the radial direction with respect to the rotation axis L1. The lever 20 is configured to rotate about the rotation axis L1 between the first position P1 at which the operating portion 21 is adjacent to the electronic device 50 connected to the connection surface 111 in the circumferential direction with respect to the rotation axis L1, and the second position P2 at which the operating portion 21 is farther from the electronic device 50 connected to the connection surface 111 than the first position P1 in the circumferential direction and adjacent to the second wall portion 12. The restriction member 30 is attached to the operating portion 21 in a state in which, when the lever 20 is located at the first position P1, the restriction member 30 is movable along the radial direction between the restriction position P3 that the restriction member 30 is located between the operating portion 21 and the second wall portion 12 in the circumferential direction and at which the restriction member 30 restricts rotation of the lever 20, and the release position P4 that is a position farther from the rotation axis L1 than the restriction position P3 and at which restriction of rotation of the lever 20 by the restriction member 30 is released. With such a configuration, when the lever 20 is located at the first position P1, the rotation of the lever 20 can be restricted by positioning the restriction member 30 at the restriction position P3. As a result, it is possible to achieve the socket 1 capable of preventing the electronic device 50 connected thereof from dropping off due to rotation of the lever 20.

The socket 1 includes the holding mechanism 40 configured to hold the restriction member 30 at the restriction position P3 and the release position P4. Such a configuration can achieve the socket 1 capable of more reliably preventing the electronic device 50 connected thereof from dropping off.

The holding mechanism 40 includes the first protruding portion 33 that is provided on the restriction member 30 and protrudes from the restriction member 30 in the width directions, the first recess 213 that is provided in the lever 20 and configured to hold the first protruding portion 33 at the restriction position P3, and the second recess 214 that is provided in the lever 20 and configured to hold the first protruding portions 33 at the release position P4. Such a configuration can achieve the socket 1 capable of preventing the electronic device 50 connected thereof from dropping off.

The restriction member 30 has the pinch portion 32, which is provided at one of two ends in the radial direction that is farther from the rotation axis L1 and is configured to be pinchable. With such a configuration, the restriction member 30 can be easily moved from the restriction position P3 to the release position P4 or from the release position P4 to the restriction position P3.

The restriction member 30 includes the main body portion 31 and the second protruding portion 34 that protrudes from the main body portion 31 in the circumferential direction toward the operating portion 21. The operating portion 21 includes the third recess 215 that extends along the radial direction, opens facing the restriction member 30 in the circumferential direction, and configured to accommodate the second protruding portions 34. The operating portion 21 is configured such that the bottom surface of the third recess 215 comes into contact with the second wall portion 12 at the second position P2. With such a configuration, it is possible to increase the rotation range of the lever 20 while restricting the movement range of the restriction member 30.

The socket 1 may be configured as follows.

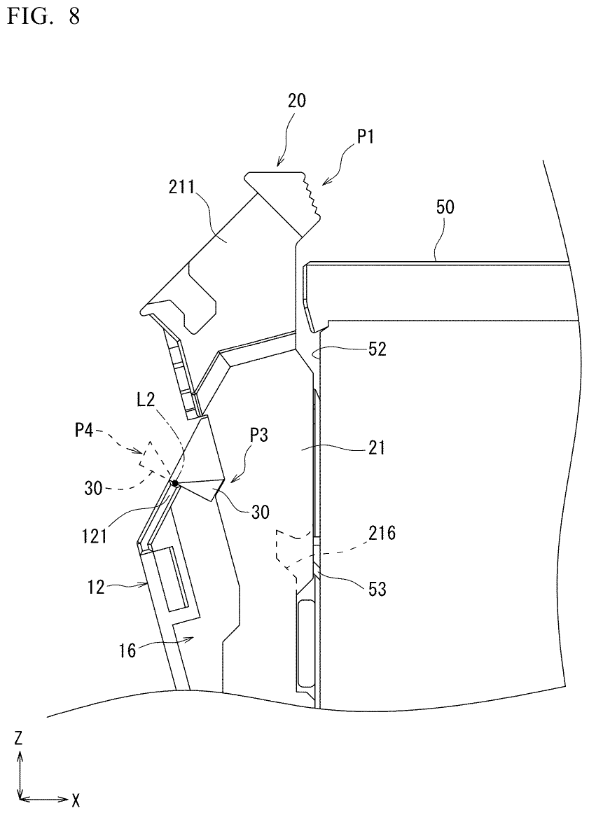

The restriction member 30 may be attached to the housing 10. For example, as illustrated in FIG. 8, the restriction member 30 may be attached to the second wall portion 12 of the housing 10. In FIG. 8, as an example, the restriction member 30 has a substantially triangular shape when viewed along the width direction Y (that is, a direction perpendicular to the drawing plane of FIG. 8). The restriction member 30 is configured to rotate between the restriction position P3 and the release position P4 about a rotation axis L2 passing through one of vertexes of the substantially triangular shape and extending in the width direction Y. The rotation axis L2 is located at a distal end 121 of the second wall portion 12 facing the operating portion 21. The shape of the restriction member 30 may be modified according to a configuration, a shape, and the like of the lever 20.

The restriction member 30 may have any configuration that allows the restriction member 30 to be attached to the operating portion 21 in a state in which, when the lever 20 is located at the first position P1, the restriction member 30 is movable along the radial direction between the restriction position P3 and the release position P4. For example, the number of the first protruding portion 33 and the number of the second protruding portion 34 are not limited to two, and may be one or three or more. At least one of the pinch portion 32 and the second protruding portion 34 may be omitted.

The holding mechanism 40 may be omitted.

The holding mechanism 40 may have any configuration as long as it can hold the restriction member 30 at at least one of the restriction position P3 and the release position P4. For example, in addition to or instead of the first protruding portion 33, the second protruding portion 34, the first recess 213, and the second recess 214, the holding mechanism 40 may include another configuration configured to hold the restriction member 30 at at least one of the restriction position P3 and the release position P4. The operating portion 21 may be configured to include only either of the first recess 213 and the second recess 214, or may be configured to include one of first recess 213 and second recess 214 or three or more of first recesses 213 and second recesses 214.

For example, the number of the first recess 213 and the number of the second recess 214 are not limited to two, and may be one or three or more.

The present disclosure is not limited to the socket 1, and may be applied to a socket having the following configuration.
The socket includes a housing including a connection surface to which an electronic device is to be connected and a wall portion that is positioned with a gap from the connection surface in a first direction, which is a direction along the connection surface, and extends in a second direction intersecting the connection surface.
The socket includes a lever that is attached to the housing so as to be rotatable about a rotation axis extending along the connection surface between the connection surface and the wall portion, and configured to release connection of the electronic device by being rotated about the rotation axis.
The lever includes an operating portion extending from the rotation axis in a radial direction with respect to the rotation axis.
The lever is configured to rotate about the rotation axis between a first position at which the operating portion is adjacent to the electronic device in the circumferential direction with respect to the rotation axis, and a second position at which the operating portion is farther from the electronic device than the first position in the circumferential direction and adjacent to the wall portion.

Various embodiments of the present disclosure have been described above in detail with reference to the drawings. Finally, various aspects of the present disclosure will be described. In the following description, as an example, reference numerals are added.

A socket 1 according to a first aspect of the present disclosure includes:
a housing 10 including a first wall portion 11 including a connection surface 111 to which an electronic device is to be connected and a second wall portion 12 that is positioned with a gap 16 from the first wall portion 11 in a first direction, which is a direction along the connection surface 111, and extends in a second direction intersecting the connection surface 111;
a lever 20 that is located in the gap 16, attached to the housing 10 in a state in which the lever 20 is rotatable about a rotation axis L1 extending along the connection surface 111, and configured to release connection of the electronic device by being rotated about the rotation axis L1; and
a restriction member 30 configured to restrict rotation of the lever 20, in which
the lever 20 includes an operating portion 21 extending from the rotation axis L1 in a radial direction with respect to the rotation axis L1, and
the lever 20 is configured to rotate about the rotation axis L1 between a first position Pl at which the operating portion 21 is adjacent to the electronic device connected to the connection surface 111 in a circumferential direction with respect to the rotation axis L1, and a second position P2 at which the operating portion 21 is farther from the electronic device connected to the connection surface 111 in the circumferential direction than the first position P1 and adjacent to the second wall portion 12, and
the restriction member 30 is attached to the housing or the operating portion 21 in a state in which, when the lever 20 is located at the first position P1, the restriction member 30 is movable along the radial direction between a restriction position P3 that the restriction member 30 is located between the operating portion 21 and the second wall portion 12 in the circumferential direction and at which the restriction member 30 restricts rotation of the lever 20, and a release position P4 that is a position farther from the rotation axis L1 in the radial direction than the restriction position P3 and at which restriction of rotation of the lever 20 by the restriction member 30 is released.

The socket 1 according to a second aspect of the present disclosure includes
a holding mechanism 40 configured to hold the restriction member 30 at at least one of the restriction position P3 and the release position P4.

The socket 1 according to a third aspect of the present disclosure, in which
the holding mechanism 40 includes:
a first protruding portion 33 that is provided on the restriction member 30 and protrudes from the restriction member 30 in a width direction intersecting the circumferential direction and the radial direction;
a first recess 213 that is provided in the lever 20 and configured to hold the first protruding portion 33 at the restriction position P3; and
a second recess 214 that is provided in the lever 20 and configured to hold the first protruding portion 33 at the release position P4.

The socket 1 according to a fourth aspect of the present disclosure, in which
the restriction member 30 includes a pinch portion 32 that is provided at one of two ends in the radial direction that is farther from the rotation axis L1, the pinch portion 32 being configured to be pinched.

The socket 1 according to a fifth aspect of the present disclosure, in which
the restriction member 30 includes:
a main body portion 31; and
a second protruding portion 34 that protrudes from the main body portion 31 in the circumferential direction toward the operating portion 21, and
the operating portion 21 includes a third recess 215 that extends along the radial direction, opens facing the restriction member 30 in the circumferential direction, and configured to accommodate the second protruding portion 34, and
is configured such that a bottom surface of the third recess 215 comes into contact with the second wall portion 12 at the second position P2.

By appropriately combining arbitrary embodiments or modifications among the various embodiments or modifications, it is possible to achieve the respective effects. In addition, combinations of embodiments, combinations of examples, or combinations of embodiments and examples are possible, and combinations of features in different embodiments or examples are also possible.

Although the present disclosure has been fully described in connection with preferred embodiments with reference to the accompanying drawings, various modifications and changes will be apparent to those skilled in the art. Such modifications and changes are to be understood as being included within the scope of the present disclosure as set forth in the appended claims.

### INDUSTRIAL APPLICABILITY

The socket of the present disclosure is applicable to a terminal block to which an electromagnetic relay can be connected, for example.

### EXPLANATION OF REFERENCES

1 socket
10 housing
101 housing main body
102 lid portion
103 opening
11 first wall portion
111 connection surface
12 second wall portion
13 attachment portion
14 wiring connection portion
15 projection
16 gap
17 terminal connection portion
20 lever
21 operating portion
211, 212 end portion
213 first recess
214 second recess
215 third recess
216 fourth recess
217 inclined surface
22 contact portion
221 distal end portion
23 support wall portion
231 groove portion
232 bottom surface
30 restriction member
31 main body portion
311 wall portion
312 gap
32 pinch portion
33 first protruding portion
34 second protruding portion
40 holding mechanism
50 electronic device
51 bottom portion
52 side portion
53 projection
120 terminal

1. A socket, comprising:
a housing including a first wall portion including a connection surface to which an electronic device is to be connected, and a second wall portion that is positioned with a gap from the first wall portion in a first direction, which is a direction along the connection surface, and extends in a second direction intersecting the connection surface;
a lever that is located in the gap, attached to the housing in a state in which the lever is rotatable about a rotation axis extending along the connection surface, and configured to release connection of the electronic device by being rotated about the rotation axis; and
a restriction member configured to restrict rotation of the lever, wherein
the lever includes an operating portion extending from the rotation axis in a radial direction with respect to the rotation axis, and
the lever is configured to rotate about the rotation axis between a first position at which the operating portion is adjacent to the electronic device connected to the connection surface in a circumferential direction with respect to the rotation axis, and a second position at which the operating portion is farther from the electronic device connected to the connection surface in the circumferential direction than the first position and adjacent to the second wall portion, and
the restriction member is attached to the housing or the operating portion in a state in which, when the lever is located at the first position, the restriction member is movable along the radial direction between a restriction position that the restriction member is located between the operating portion and the second wall portion in the circumferential direction and at which the restriction member restricts rotation of the lever, and a release position that is a position farther from the rotation axis in the radial direction than the restriction position and at which restriction of rotation of the lever by the restriction member is released.

2. The socket according to claim 1, comprising
a holding mechanism configured to hold the restriction member at at least one of the restriction position and the release position.

3. The socket according to claim 2, wherein
the holding mechanism includes:
a first protruding portion that is provided on the restriction member and protrudes from the restriction member in a width direction intersecting the circumferential direction and the radial direction;
a first recess that is provided in the lever and configured to hold the first protruding portion at the restriction position; and
a second recess that is provided in the lever and configured to hold the first protruding portion at the release position.

4. The socket according to claim 1, wherein
the restriction member includes a pinch portion that is provided at one of two ends in the radial direction that is farther from the rotation axis, the pinch portion being configured to be pinched.

5. The socket according to claim 1, wherein
the restriction member includes:
a main body portion; and
a second protruding portion that protrudes from the main body portion in the circumferential direction toward the operating portion,
the operating portion includes a third recess that extends along the radial direction, opens facing the restriction member in the circumferential direction, and configured to accommodate the second protruding portion, and
the operating portion is configured such that a bottom surface of the third recess comes into contact with the second wall portion at the second position.

6. The socket according to claim 2, wherein
the restriction member includes a pinch portion that is provided at one of two ends in the radial direction that is farther from the rotation axis, the pinch portion being configured to be pinched.

7. The socket according to claim 3, wherein
the restriction member includes a pinch portion that is provided at one of two ends in the radial direction that is farther from the rotation axis, the pinch portion being configured to be pinched.

8. The socket according to claim 2, wherein
the restriction member includes:
a main body portion; and
a second protruding portion that protrudes from the main body portion in the circumferential direction toward the operating portion,
the operating portion includes a third recess that extends along the radial direction, opens facing the restriction member in the circumferential direction, and configured to accommodate the second protruding portion, and
the operating portion is configured such that a bottom surface of the third recess comes into contact with the second wall portion at the second position.

9. The socket according to claim 3, wherein
the restriction member includes:
a main body portion; and
a second protruding portion that protrudes from the main body portion in the circumferential direction toward the operating portion,
the operating portion includes a third recess that extends along the radial direction, opens facing the restriction member in the circumferential direction, and configured to accommodate the second protruding portion, and
the operating portion is configured such that a bottom surface of the third recess comes into contact with the second wall portion at the second position.

10. The socket according to claim 4, wherein
the restriction member includes:
a main body portion; and
a second protruding portion that protrudes from the main body portion in the circumferential direction toward the operating portion,
the operating portion includes a third recess that extends along the radial direction, opens facing the restriction member in the circumferential direction, and configured to accommodate the second protruding portion, and
the operating portion is configured such that a bottom surface of the third recess comes into contact with the second wall portion at the second position.

11. The socket according to claim 6, wherein
the restriction member includes:
a main body portion; and
a second protruding portion that protrudes from the main body portion in the circumferential direction toward the operating portion,
the operating portion includes a third recess that extends along the radial direction, opens facing the restriction member in the circumferential direction, and configured to accommodate the second protruding portion, and
the operating portion is configured such that a bottom surface of the third recess comes into contact with the second wall portion at the second position.

12. The socket according to claim 7, wherein
the restriction member includes:
a main body portion; and
a second protruding portion that protrudes from the main body portion in the circumferential direction toward the operating portion,
the operating portion includes a third recess that extends along the radial direction, opens facing the restriction member in the circumferential direction, and configured to accommodate the second protruding portion, and
the operating portion is configured such that a bottom surface of the third recess comes into contact with the second wall portion at the second position.
